(19) United States
(12) Patent Application Publication
(10) Pub. No.: US 2023/0305995 A1
(43) Pub. Date: Sep. 28, 2023

(54) INFORMATION PROCESSING APPARATUS, NON-TRANSITORY COMPUTER READABLE MEDIUM STORING PROGRAM, AND INFORMATION PROCESSING METHOD

(71) Applicant: FUJIFILM Business Innovation Corp., Tokyo (JP)

(72) Inventor: Shiori ARAI, Kanagawa (JP)

(73) Assignee: FUJIFILM Business Innovation Corp., Tokyo (JP)

(21) Appl. No.: 17/862,387

(22) Filed: Jul. 11, 2022

(30) Foreign Application Priority Data
Mar. 25, 2022 (JP) 2022-049610

(51) Int. Cl. G06F 16/11

(52) U.S. Cl. CPC G06F 16/116

(57) ABSTRACT

An information processing apparatus includes a processor configured to, in a case where a document is converted to a document in a document format that is displayed in a state where the document is actually printed on a page, manage the documents before and after conversion in association with each other, extract an object that is displayed to straddle pages in the document after the conversion from the document before the conversion associated with the document after the conversion, and convert the extracted object into the document format.

### CROSS-REFERENCE TO RELATED APPLICATIONS

This application is based on and claims priority under 35 USC 119 from Japanese Patent Application No. 2022-049610 filed Mar. 25, 2022.

### BACKGROUND

### (i) Technical Field

The present invention relates to an information processing apparatus, a non-transitory computer readable medium storing a program, and an information processing method.

### (ii) Related Art

A plurality of users may share a document. In a case where a document that is a sharing target is created by using a document application, users who are not in a system environment in which the document application can be used cannot view the shared document. In order to avoid this, for example, a file format that can handle documents in the same manner without special software, for example, a

Portable Document Form (PDF) file or the like may be converted and shared. A PDF file is a document in a document format that is displayed in a state when the document is actually printed on a page.

### SUMMARY

In a case where a document is converted into a document in a document format that is displayed in a state when the document is actually printed on a page, there is a case where an object such as a figure or a table does not straddle pages in the document before the conversion but straddles in the document after the conversion. An object may be difficult to refer to in a state in which the object straddles pages. Therefore, in order to obtain an object that does not straddle pages, it is troublesome to find a document before conversion and recreate the object that does not straddle pages from the document before conversion.

Aspects of non-limiting embodiments of the present disclosure relate to an information processing apparatus, a non-transitory computer readable medium storing a program, and an image processing method capable of providing an object that does not straddle pages without reconverting the whole document before conversion in a case where the object included in the document before conversion is displayed to straddle pages due to conversion into a document format that is stored in a state when the document is actually printed on a page.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a processor configured to, in a case where a document is converted to a document in a document format that is displayed in a state when the document is actually printed on a page, manage the documents before and after conversion in association with each other; extract an object that is displayed to straddle pages in the document after the conversion from the document before the conversion associated with the document after the conversion; and convert the extracted object into the document format.

### BRIEF DESCRIPTION OF THE DRAWINGS

Exemplary embodiment(s) of the present invention will be described in detail based on the following figures, wherein:

FIG. 1 is a diagram showing an example of an overall configuration of a network system and a block configuration of a cloud system according to the present exemplary embodiment;

FIG. 2 is a flowchart showing a process at the time of upload according to the present exemplary embodiment;

FIG. 3 is a diagram showing a screen display example in a user terminal of the present exemplary embodiment;

FIG. 4 is a diagram showing an example of a data structure of document management information stored in a document management information storage unit according to the present exemplary embodiment;

FIG. 5 is a diagram showing a screen display example on a user terminal after a PDF file is provided in the present exemplary embodiment;

FIG. 6 is a flowchart showing a document management process according to the present exemplary embodiment;

FIG. 7 is a conceptual diagram showing a configuration of a PDF file after only an object is extracted from an original document and converted to PDF in the present exemplary embodiment;

FIG. 8 is a diagram showing another example of a data configuration of document management information stored in the document management information storage unit according to the present exemplary embodiment;

FIG. 9 is a diagram showing a screen display example on the user terminal after a table (PDF) is provided in the present exemplary embodiment;

FIG. 10 is a conceptual diagram showing a state in which a table (PDF) is combined with a document (PDF) in the present exemplary embodiment; and

FIG. 11 is a conceptual diagram showing a state in which a table (PDF) is attached to a document (PDF) in the present exemplary embodiment.

### DETAILED DESCRIPTION

Hereinafter, exemplary embodiments of the present invention will be described with reference to the drawings.

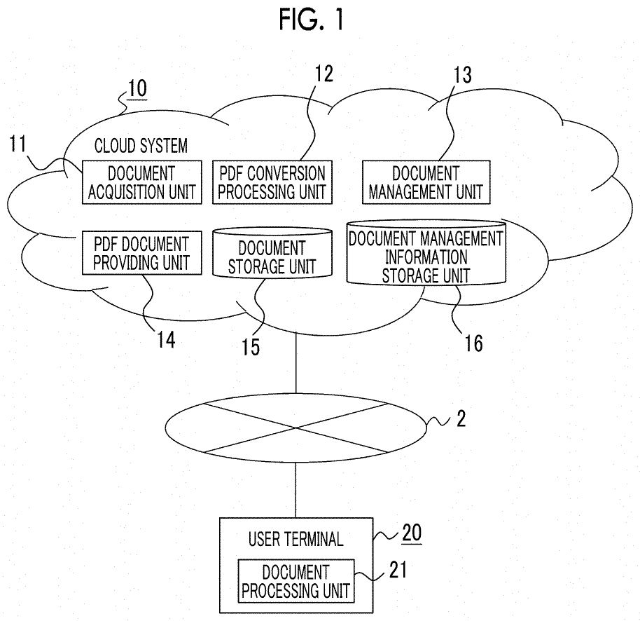

FIG. 1 is a diagram showing an example of an overall configuration of a network system and a block configuration of a cloud system 10 in the present exemplary embodiment. FIG. 1 shows a network system in which the cloud system 10 and a user terminal 20 are connected via the Internet 2.

The user terminal 20 is an information processing apparatus used by a user who uses the cloud system 10 for document management and the like. The user terminal 20 may be implemented by, for example, a general-purpose personal computer (PC). That is, the user terminal 20 is configured as a hardware configuration by connecting a CPU, a ROM, a RAM, and a hard disk drive (HDD) as storage means, a user interface, and a network interface as communication means connected to the Internet 2 to an internal bus. The user interface has input means such as a mouse and a keyboard and display means such as a display. Alternatively, the user interface may be configured with a touch panel or the like that also serves as input means and display means.

A document application having functions such as creating, editing, and viewing a document is installed in the user terminal 20, and a document processing unit 21 performs a predetermined process on a document by using the functions of the document application. As the document application, there is, for example, an office application of Microsoft Corporation, various pieces of software that handles PDF of Adobe System, and DocuWorks (registered trademark) of Fuji Xerox Business Innovation. The document processing unit 21 realizes a document process by linking one document application or a plurality of document applications. A web browser may be used to view a document. In any case, the document processing unit 21 executes a process related to a document on the user terminal 20.

Although the network system includes a plurality of user terminals, it is sufficient that each of the user terminals has a processing function equivalent to a processing function described below. Therefore, only one user terminal 20 is shown in FIG. 1.

The cloud system 10 is a system built by using a part of cloud computing, and is realized by one or a plurality of computers related to a form of the information processing apparatus according to one exemplary embodiment of the present invention. The computer has a CPU, a ROM, storage means, a network interface as a communication means for connection to the Internet 2, and the like as hardware configuration. The cloud system 10 has a document acquisition unit 11, a PDF conversion processing unit 12, a document management unit 13, a PDF document providing unit 14, a document storage unit 15, and a document management information storage unit 16. Constituents not used in the description of the present exemplary embodiment are not illustrated in the drawings.

The document acquisition unit 11 acquires a document uploaded from the user terminal 20. The document handled in the present exemplary embodiment is an electronic document in a file format. The “document” and “document file” used in the present exemplary embodiment refer to electronic documents having an identical file format. The document file may include an object such as a figure or a table as well as text characters. The document file handled in the present exemplary embodiment is a document that can include an object and in which a hyperlink can be set, and is, for example, a document created by using an office application of Microsoft Corporation.

The “hyperlink” that is also referred to simply as a “link” is reference information to other information resources embedded in an information resource such as a document, and is defined as an element in a document such as text or an image in which such a reference is set. In general, inserting a link in a document may be expressed as “setting a link” or “creating a link”. In the following description, inserting a link is inserted or setting a link refers to an identical operation.

The PDF conversion processing unit 12 converts the document file acquired by the document acquisition unit 11 into a document file in a PDF format. In the present exemplary embodiment, a “document in a PDF format” or a “PDF document” will be referred to as a “PDF file” such that a document in a PDF format and a document file in other formats are not confused. In the present exemplary embodiment, “conversion into a PDF file” will also be referred to as “PDF conversion”. A PDF file is a document in a document format that can be viewed without depending on a software environment, and is an example of a document in a document format that is displayed in a state when the document is actually printed on a page.

The document management unit 13 stores and manages document files handled by the cloud system 10 in the document storage unit 15. The document management unit 13 manages documents before and after PDF conversion, that is, a document file acquired by the document acquisition unit 11 and a PDF file created through the PDF conversion by the PDF conversion processing unit 12 in association with each other. Document management information indicating a relationship of the association of files is managed by being registered in the document management information storage unit 16.

The PDF document providing unit 14 provides the PDF file created through the conversion by the PDF conversion processing unit 12 to the user terminal 20 that is an upload source of an original document, that is, the document file acquired by the document acquisition unit 11.

Each of the constituents 11 to 14 in the cloud system 10 is realized through a cooperative operation between a computer forming the cloud system 10 and a program operated by a CPU mounted on the computer. Each of the storage units 15 and 16 is realized by the storage means included in the cloud system 10.

The program used in the present exemplary embodiment may be provided not only by communication means but also by being stored in a computer readable recording medium such as a CD-ROM or a USB memory. Programs provided by communication means or a recording medium are installed in a computer, and various processes are realized by a CPU of the computer sequentially executing the programs.

A user may use a document application to insert an object such as a figure or a table to create a document. In a case where this document is shared by a plurality of users, a document file may be converted into a PDF file and then attached to an e-mail such that a user who is not using the document application that has created the document can refer to the document. A user who has acquired the PDF file displays the PDF-converted document on a screen to be viewed or to be printed from a page printer.

However, in a case where the created document (the above “original document”) is viewed with the document application that has created the document, even in a case where an object in the document is not displayed in a state of straddling pages, the object may be displayed in a state of straddling the pages after the document is converted into a PDF file. As described above, in a case where one object is displayed to straddle pages, it is difficult to refer to the object. In order to prevent this, work such as changing a layout of the original document may occur.

Therefore, the present exemplary embodiment is characterized in that, in a case where an object is displayed in a state of straddling pages after an original document is converted into a PDF file even in a case where the object is displayed in a state in which the object does not straddle pages in the original document, it is possible to provide the object that does not straddle the pages without reconverting the entire original document.

Hereinafter, an operation of the present exemplary embodiment will be described.

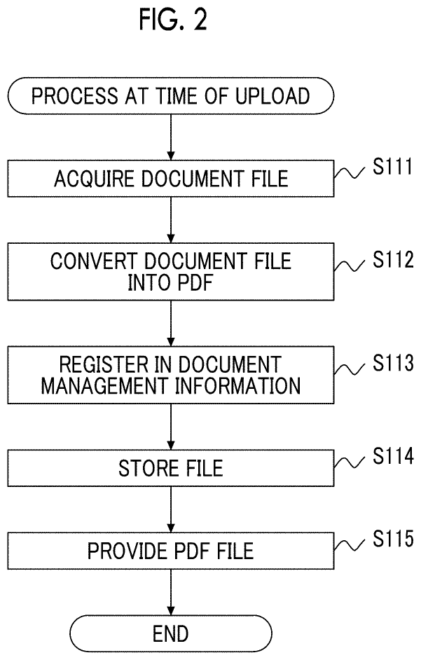

In the present exemplary embodiment, a user shares a document file by being uploaded to the cloud system 10. The cloud system 10 manages the uploaded document file through PDF conversion. A process performed in the present exemplary embodiment at the time of this upload will be described with reference to a flowchart of FIG. 2.

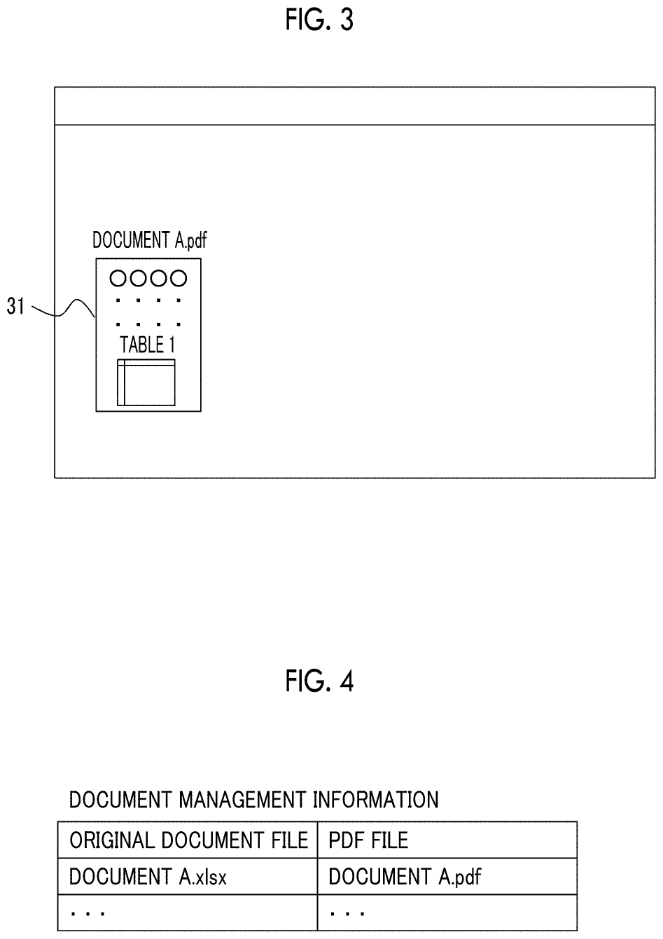

For example, a user starts a predetermined application, displays an icon (hereinafter, also simply referred to as a “document file”) 31 for identifying an upload target document file as shown in FIG. 3 on a screen, and gives an instruction for uploading the document file 31 by performing a predetermined operation. The predetermined application uploads the document file 31 in response to the instruction from the user.

In the cloud system 10, in a case where the document acquisition unit 11 acquires the document file uploaded from the user terminal 20 (step 111), the PDF conversion processing unit 12 performs a PDF conversion process on the document file to create the PDF file (step S1 step S112). For the PDF conversion process, a processing function of the related art may be used.

The document management unit 13 associates the document file before conversion with the PDF file after conversion, and registers the associated information in the document management information storage unit 16 as document management information (step S113).

FIG. 4 is a diagram showing an example of a data configuration of document management information stored in the document management information storage unit 16 in the present exemplary embodiment. As shown in FIG. 4, an original document file and a PDF file are registered in correlation with each other in the document management information. Specifically, file identification information (a “file name” in the present exemplary embodiment) is set in the document management information instead of the entity of the file. The original document file is a document file that is a conversion target into PDF. The PDF file is a document file created by converting the original document file into PDF.

In a case where the original document file and the PDF file are associated with each other, the document management unit 13 stores each file in a predetermined storage location of the document storage unit 15 (step S114). The storage location is not particularly limited, and may be, for example, a folder that can be accessed by a plurality of users sharing a document file.

Subsequently, the PDF document providing unit 14 provides the created PDF file to the user terminal 20 that is an upload source of the original document (step S115). Information to be provided or a provision method may be matched to a software environment of the user terminal 20. For example, the entity of the PDF file may be transmitted at this point, or information necessary for display on the user terminal 20, such as information for associating the original document with the PDF file, an icon image of the PDF file, or a thumbnail image (hereinafter, collectively referred to as an “icon”) may be transmitted instead of transmission of the entity. For example, in a case where the user terminal 20 displays the screen by using a browser, the PDF document providing unit 14 provides a page (HyperText Markup Language (HTML) file) for displaying the screen. The PDF document providing unit 14 sets each display position of the document file icon and the PDF file icon by referring to the document management information.

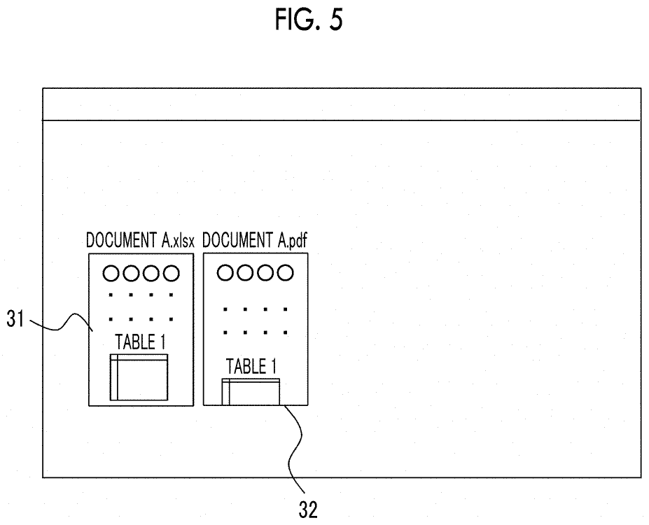

FIG. 5 is a diagram showing a screen display example on the user terminal 20 after the PDF file is provided. As shown in FIG. 5, the document processing unit 21 displays a PDF file icon 32 adjacent to the icon 31 to be associated with the uploaded document file. In other words, the document processing unit 21 displays the PDF file icon 32 at a position based on the position of the uploaded document file. In a case where the document file icon 31 is selected, the document file is opened by a predetermined document application. In a case where the PDF file icon 32 is selected, the PDF file is opened by a predetermined document application or a PDF file viewing application.

Incidentally, as described above, even an object that is not displayed to straddle pages in a case where a document file (the above “original document”) created by a predetermined document application is displayed by using the document application may be displayed in a state of straddling pages in a case where the document is converted into PDF. In this case, the user can eliminate such inconvenient display as follows. The document application displaying the icons 31 and 32 controls display as follows according to a user operation that will be described later.

For example, in a case where the user places a cursor on an icon located at the upper right of the PDF file icon 32 with the mouse, the PDF file is enlarged and displayed. The enlarged display image displayed through this operation may be prepared in, for example, the cloud system 10. The user can lock the enlarged display by clicking the mouse in a state in which the cursor is placed on the enlarged display image.

The user can turn a page of the enlarged display image. It is assumed that an object that is difficult to see due to straddling of pages is found by referring to the enlarged display image. In this case, the user displays a menu screen through a predetermined operation, selects a partial output function from the menu screen, and then selects the object straddling the pages in order to designate the object that is a partially output target. The document application gives an instruction for converting the object into PDF by transmitting identification information of each of the PDF file and the selected object to the cloud system 10 in response to this user operation. As long as the PDF file that is a processing target and instruction information including information for identifying the object can be sent to the cloud system 10, the user operation until the object is selected is not limited to the above operation.

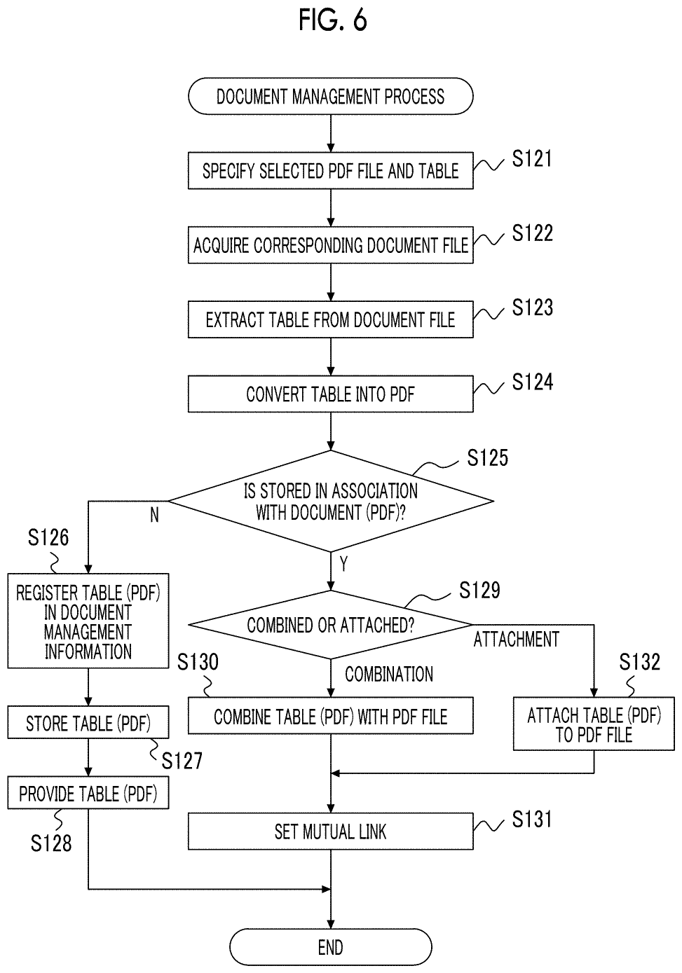

Hereinafter, a document management process in the present exemplary embodiment will be described with reference to the flowchart of FIG. 6. Here, a table will be described as an example as an object.

In a case where the PDF file and the table are specified by receiving the instruction information transmitted from the user terminal 20 (step S121), the document management unit 13 extracts the table displayed to straddle pages in the PDF file from an original document file associated with the performed file. Therefore, the document management unit 13 specifies the original document file corresponding to the PDF file by referring to the document management information, and reads and acquires the specified original document file from the document storage unit 15 (step S122). According to the setting example of the document management information shown in FIG. 4, in a case where the PDF file is “Document A.pdf”, the original document can be specified as “Document A.xlsx”. Subsequently, the PDF conversion processing unit 12 extracts the table selected by the user from the acquired original document (step S123), and converts only the table into PDF (step S124). In the present exemplary embodiment, only the table selected by the user is targeted for PDF conversion again, not the entire original document.

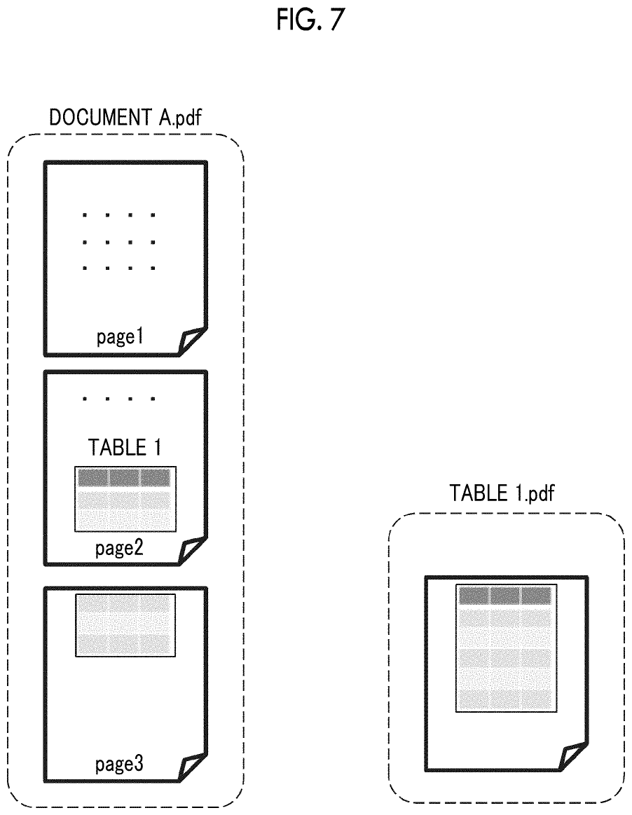

FIG. 7 is a conceptual diagram showing a configuration of the PDF file created through the above process. The Document A.pdf is a PDF file created in step S112 in the process at the time of upload. The Document A.pdf includes a table 1, but as shown in FIG. 7, Table 1 is included in the PDF file in a state of straddling a plurality of pages, that is, the second page and the third page. As described above, the user gives an instruction for displaying the table 1 in a state in which the table 1 does not straddle the pages by using the partial output function from the enlarged display image. Consequently, the PDF conversion processing unit 12 creates the PDF file “Table 1.pdf” in step S124. The table 1 straddles the two pages in the Document A.pdf but straddles two pages, but does not straddle the pages in the Table 1.pdf. In the present exemplary embodiment, the PDF file created from the original document has a file name identical to a file name of the original document, and the PDF file of the object has the object name. However, the PDF file may be named according to a predetermined rule. In the following description, a PDF file created by converting an original document to PDF will be referred to as a “document (PDF)”, a PDF file created by extracting a table from the original document and converting the table to PDF will be referred to as a “table (PDF)”, and the document (PDF) and the table (PDF) will be collectively referred to as a “PDF file”.

In a case where the table (PDF) is created without straddling pages as described above, the document management unit 13 manages the table (PDF) as follows. The user may be allowed to select a management method, or for example, a management method may be automatically selected with an attribute such as an object size as a selection condition.

First, in a case where the table (PDF) is not managed in association with the document (PDF) (N in step S125), the document management unit 13 associates the document file 31 with the table (PDF), and registers the associated information as document management information in the document management information storage unit 16 (step S126).

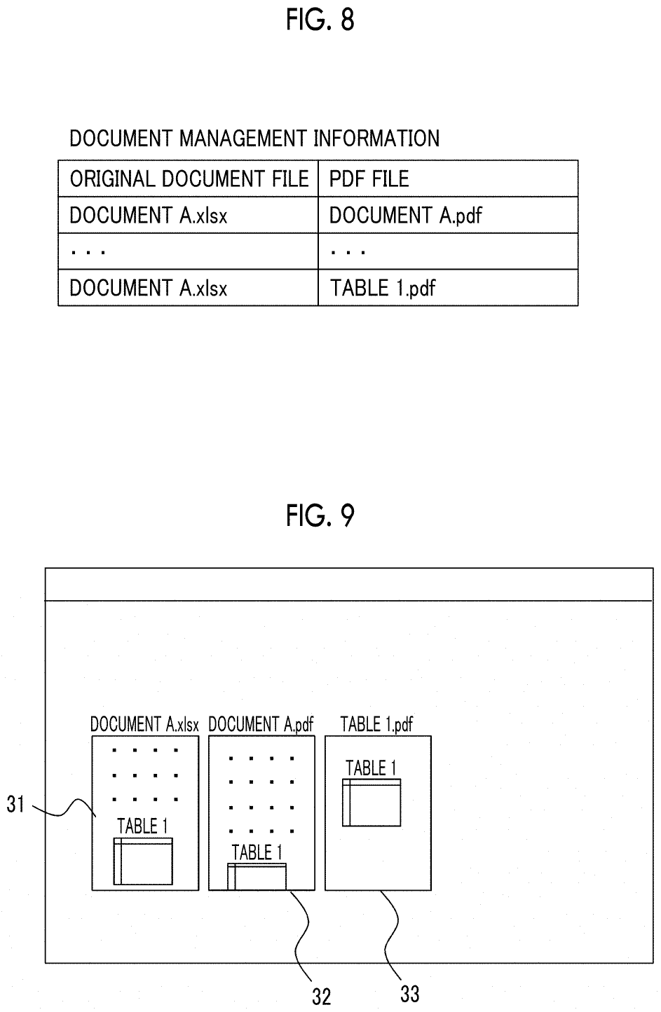

FIG. 8 is a diagram showing another example of a data configuration of the document management information stored in the document management information storage unit 16 in the present exemplary embodiment, and is a diagram showing a data configuration after the table (PDF) is created in a case where the table (PDF) is not managed in association with the document (PDF). As is clear from the comparison with FIG. 4, in a case where the table (PDF) is created, the original document file and the table (PDF) are registered in the document management information in correlation with each other as shown in FIG. 8. Specifically, file identification information (a “file name” in the present exemplary embodiment) is set in the document management information instead of the entity of the file. As described above, the table (PDF) is not directly associated with the document (PDF).

Subsequently, in a case where the original document and the table (PDF) are associated with each other, the document management unit 13 stores the table (PDF) in a predetermined storage location (step S127). The storage location is not particularly limited, and may be a folder that can be accessed by a plurality of users sharing a document (PDF). For example, a folder identical to a folder of the document (PDF) may be used.

Subsequently, the PDF document providing unit 14 provides the created table (PDF) to the user terminal 20 that is an upload source of the original document (step S128). Although “providing” has been described with reference to FIG. 5, in a case where the user terminal 20 displays the screen on the browser, the PDF document providing unit 14 provides a page for displaying the screen. The PDF document providing unit 14 sets a display position of each of the document file, the document (PDF), and the table (PDF) by referring to the document management information.

FIG. 9 is a diagram showing a screen display example on the user terminal 20 after the table (PDF) is provided. As shown in FIG. 9, the document processing unit 21 displays an icon 33 of the table (PDF) adjacent to the icon 32 to be associated with the icons 31 and 32 of the uploaded document file and the document (PDF). In a case where the icon 33 of the table (PDF) is selected, the table (PDF) is opened by a predetermined document application or a PDF file viewing application. That is, the table 1 is displayed in a state of not straddling pages.

On the other hand, in a case where the table (PDF) is managed in association with the document (PDF) (Y in step S125), the document management unit 13 determines whether to perform the association through combination or attachment. The user may select an association method, or a process may be performed such that an attachment condition or a combination condition is set in advance, and attachment is automatically selected in a case where the attachment condition is satisfied, or combination may be automatically selected in a case where the combination condition is not satisfied or the attachment condition is satisfied.

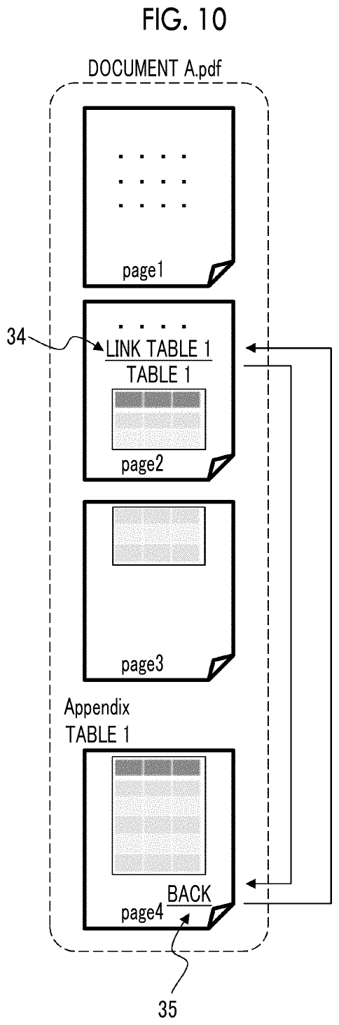

Here, in a case where combination is selected (“combination” in step S129), the document management unit 13 combines the table (PDF) with the document (PDF) as an appendix to be stored (step S130). The “combination” in the present exemplary embodiment means that a plurality of files are integrally formed, that is, one file is generated. A document (PDF) in this state is shown in FIG. 10.

As illustrated in FIG. 10, the table (PDF) becomes a part of the document (PDF) by being incorporated into the document (PDF). In the present exemplary embodiment, the table (PDF) is added to the end of the document (PDF) as an appendix to be combined, but a combination position in the document (PDF) is not limited to this.

According to the present exemplary embodiment, the table 1 displayed to straddle pages in a document (PDF) is converted into PDF from the original document and combined with the document (PDF). However, according to the document (PDF) shown in FIG. 10, the table 1 that does not straddle pages is moved to the end of the document, not the position of the table 1 in the document (PDF). In a case where the number of pages of a document (PDF) is huge, it is troublesome to move between pages.

Therefore, in the present exemplary embodiment, an in-document link (also referred to as a “mutual link”) is set between the converted document of the original document, that is, the position of the table 1 in the document (PDF) and the position of the table 1 converted into PDF, that is, the combination position of the table (PDF) (step S131). This mutual link will be described with reference to FIG. 10.

The document management unit 13 inserts text (“link table 1”) 34 at the position of table 1 in the combined document (PDF) shown in FIG. 10 to set a hyperlink. The text 34 does not have to be limited to this example. In FIG. 10, the text is inserted immediately before the table 1, but is not limited to this, and may be inserted immediately after the table 1 or in the table, for example. The hyperlink set in the text 34 is an in-document link to the table (PDF). Therefore, in a case where the user clicks the text 34, the table (PDF) is displayed on the screen.

On the other hand, the document management unit 13 inserts text (“back”) 35 in the page of the table (PDF) to set a hyperlink. The text 35 does not have to be limited to this example. An insertion position of the text 35 is not limited to the position shown in FIG. 10. The hyperlink set in the text 35 is an in-document link to the position of the table 1 in the document (PDF).

On the other hand, in a case where attachment is selected (“attachment” in step S129), the document management unit 13 stores the table (PDF) as an attached file 36 of the document (PDF) (step S132). A storage destination of the attached file 36 is predetermined as a predetermined folder in the document storage unit 15, but the user may be inquired in a case of storing the file.

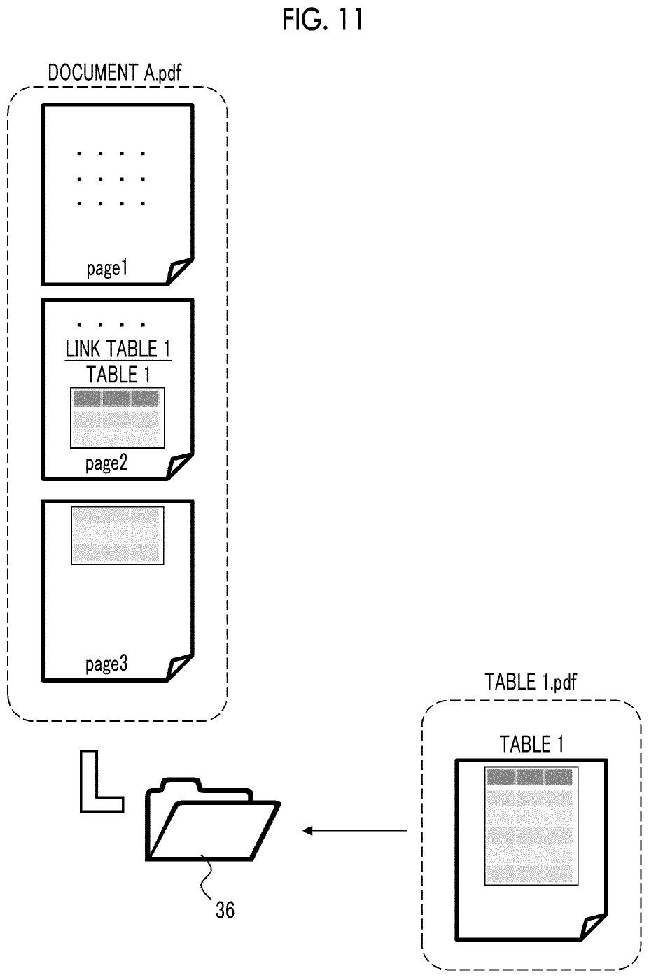

As an “attachment” method, an attached file of a document (PDF) may be used, or a portfolio function provided by an application of Adobe Systems Incorporated may be used. Here, an attached table (PDF) will be collectively referred to as an “attached file”. FIG. 11 is a conceptual diagram in a case where a table (PDF) is stored as the attached file 36 of a document (PDF).

Incidentally, in the case of “combination” in which the table 1 is integrally formed with a document (PDF), the cloud system 10 needs to convert the table 1 into PDF to create a table (PDF). However, in a case where the table 1 is “attached” to the document (PDF), the cloud system 10 manages the table (PDF) as a separate file from the document (PDF). Therefore, in a case where a user who shares the document (PDF) is using the document application that has created the original document, the cloud system 10 does not necessarily have to convert the table 1 into PDF. Therefore, the cloud system 10 may extract the table 1 from the original document, create a document file including only the table 1, and associate the document file with the document (PDF) as the attached file 36.

After the table (PDF) is set as the attached file 36, the document management unit 13 sets a mutual link between the document (PDF) and the table (PDF) (step S131), but this setting process has already been described, and thus description thereof will be omitted here.

In the present exemplary embodiment, an object straddling pages has been described, but the present exemplary embodiment is applicable, for example, in a case where an object that does not straddle pages is to be handled separately from the body (that is, the document (PDF)).

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a processor configured to:
in a case where a document is converted to a document in a document format that is displayed in a state when the document is actually printed on a page, manage the documents before and after conversion in association with each other;
extract an object that is displayed to straddle pages in the document after the conversion from the document before the conversion associated with the document after the conversion; and
convert the extracted object into the document format.

2. The information processing apparatus according to claim 1,
wherein the processor combines the object converted into the document format in the document after the conversion and stores the object.

3. The information processing apparatus according to claim 1,
wherein the processor attaches the object converted into the document format to the document after the conversion and stores the object.

4. The information processing apparatus according to claim 1,
wherein the processor sets an in-document link between a position of the object in the document after the conversion and the object converted into the document format.

5. A non-transitory computer readable medium storing a program causing a computer to realize:
a function of, in a case where a document is converted to a document in a document format that is displayed in a state when the document is actually printed on a page, managing the documents before and after conversion in association with each other;
a function of extracting an object that is displayed to straddle pages in the document after the conversion from the document before the conversion associated with the document after the conversion; and
a function of converting the extracted object into the document format.

6. An information processing method comprising:
in a case where a document is converted to a document in a document format that is displayed in a state when the document is actually printed on a page, managing the documents before and after conversion in association with each other;
extracting an object that is displayed to straddle pages in the document after the conversion from the document before the conversion associated with the document after the conversion; and
converting the extracted object into the document format.
